(19) United States
(12) Patent Application Publication
(10) Pub. No.: US 2011/0108774 A1
(43) Pub. Date: May 12, 2011

(54) THERMOELECTRIC NANOCOMPOSITE, METHOD FOR MAKING THE NANOCOMPOSITE AND APPLICATION OF THE NANOCOMPOSITE

(75) Inventors: Vladimir Davidovich Blank, Troitsk Moscow (RU); Gennadii Ivanovich Pivovarov, Troitsk Moscow (RU); Mikhail Yurievich Popov, Troitsk Moscow (RU); Evgeny Vasilievich Tatyanin, Troitsk Moscow (RU)

(73) Assignee: SIEMENS AKTIENGESELLSCHAFT, Munich (DE)

(21) Appl. No.: 12/735,981

(22) PCT Filed: Feb. 29, 2008
(86) PCT No.: PCT/RU2008/000120

§ 371 Date: Nov. 24, 2010

(51) Int. Cl. H01B 1/00; B82Y 30/00; B82Y 40/00

(52) U.S. Cl. 252/506; 977/773; 977/831; 977/734; 977/742; 977/735; 977/833; 977/900

(57) ABSTRACT

A thermoelectric nanocomposite is formed from homogeneous ceramic nanoparticles formed from at least one kind of tellurium compound. The ceramic nanoparticles have an average particle size from about 5 nm to about 30 nm and particularly to about 10 nm. The ceramic nanoparticles are coated with a particle coating in each case. The particle coating is formed from at least one layer of nanostructured, substantially intact carbon material. The nanocomposite may be formed by providing a precursor powder of homogeneous ceramic nanoparticles with at least one kind of a tellurium compound. A precursor coating of nanostructured, substantially intact carbon material is provided for the precursor nanoparticles. Heat treatment of the precursor powder generates the nanocomposite by conversion of the precursor coating into the particle coating.

### CROSS REFERENCE TO RELATED APPLICATIONS

This application is based on and hereby claims priority to International Application No. PCT/RU2008/000120 filed on Feb. 29, 2008, the contents of which are hereby incorporated by reference.

### BACKGROUND OF THE INVENTION

1. Field of the Invention

This invention relates to a thermoelectric nanocomposite, a method for making the thermoelectric nanocomposite and an application of the nanocomposite.

2. Description of the Related Art

The best traditional thermoelectric (TE) materials used for heat-to-power conversion systems have a thermoelectric figure of merit ZT=S²σT/k of about 1 (S is the Seebeck coefficient, σ is the electrical conductivity, k is the thermal conductivity, T is the average temperature of a thermoelectric device with the thermoelectric materials). This limits practical applications, where ZT>2.5 is required.

For nanostructured materials ZT in the range of 2.5 to 4 was demonstrated. Main target and effect of nanostructuring is a manipulation of ZT by creating conditions for phonon-blocking/electron-transmitting effects. The nanostructured materials were synthesized using homoepitaxial growth procedure. This procedure does not provide opportunities for industrial production of nanostructured thermoelectric materials.

In WO 2006/137923 A2 a thermoelectric nanocomposite which exhibits enhanced thermoelectric properties is proposed. The nanocomposite includes two or more components. The components are semiconductors like silicon and germanium. At least one of the components comprises nanostructed material, e.g. silicon nanoparticles.

In US 2004/0187905 A1 a thermoelectric nanocomposite comprising a plurality of ceramic nanoparticles (average particle size <100 nm) and a method for making the nanocomposite are provided. The material of the nanoparticles is for example a compound like Be₂Te₃ and Sb₂Te₃. The method for making the nanocomposite comprises following steps: Providing a bulk material of the ceramic material, milling the bulk material to a ceramic powder with the ceramic nanoparticles and heat treatment of the ceramic powder. Before starting the milling process additional material like fullerenes may be added. The addition of fullerenes leads to a mechanical alloying of the ceramic powder and the fullerenes during the milling process. The resulting nanocomposite comprises inhomogeneous core shell ceramic nanoparticles. Moreover the fullerenes are destroyed during the mechanical alloying. Both lead to an undefined, hardly reproducible thermoelectric nanocomposite with hardly predictable features.

### SUMMARY OF THE INVENTION

It is one potential object to provide a thermoelectric nanocomposite with well predictable features. Another potential object is the providing of a method for making the thermoelectric nanocomposite. The method should be easy and reproducible.

The inventors propose a modification of the known thermoelectric nanocomposite and a modification of the method for making the thermoelectric nanocomposite. Specifically, the inventors propose a thermoelectric nanocomposite comprising a plurality of homogeneous ceramic nanoparticles with at least one kind of tellurium compound. The ceramic nanoparticles have an average particle size selected from a range of about 5 nm to about 30 nm and particularly to about 10 nm. The ceramic nanoparticles are coated with a particle coating. The particle coating is formed from at least one layer of nanostructured, substantially intact carbon material.

Additionally, the inventors propose a method for making a thermoelectric nanocomposite, the nanocomposite comprising: a plurality of homogeneous ceramic nanoparticles with at least one kind of tellurium compound; the homogeneous ceramic nanoparticles comprise an average particle size selected from a range of about 5 nm to about 30 nm and particularly to about 10 nm; the homogeneous ceramic nanoparticles are coated with a particle coating in each case; the particle coating comprises at least one layer with nanostructured, substantially intact carbon material, the method comprising: providing a precursor powder of a plurality of homogeneous ceramic nanoparticles with at least one kind of a tellurium compound having an average particle size selected from a range of about 5 nm to about 30 nm and particularly to about 10 nm, wherein the homogeneous ceramic nanoparticles comprise a precursor coating with nanostructured, substantially intact carbon material in each case, and heat treatment of the precursor powder such, that the nanocomposite is generated by conversion of the precursor coating into to the particle coating.

According to a preferred embodiment the average particle size is below 20 nm. A homogenous ceramic nanoparticle is throughout uniform concerning its physical and chemical features. E.g. such a nanoparticle doesn't have any core shell structure. An alloying doesn't occur. In contrast to the related art, carbon is not built in into the ceramic tellurium compound. Moreover the coating with the nanostructured carbon material is intact. This means that the carbon material is not harmed or destructed, respectively. A harming or a destruction of the nanostructured carbon material would occur in the case of mechanical alloying.

As nanostructured carbon material any suitable material or a mixture of these materials are possible. In a particular embodiment the nanostructured carbon material is selected from the group consisting of fullerenes and carbon nanotubes. The carbon nanotubes can be single wall carbon nanotubes (SWCNts) or multi wall carbon nanotubes (MWNTs).

In particular fullerenes are suitable as nanostructured carbon material. In a preferred embodiment the fullerenes are selected from the group consisting of C₃₆, C₆₀, C₇₀ and C₈₁. Just one kind of fullerenes can be used. A mixture of two or more kinds of these fullerenes is possible, too.

The nanostructured carbon material can be used unmodified. A base material of the nanostructured carbon material is used. In a further embodiment the nanostructured carbon material is chemically modified. This means that one or more derivatives of the nanostructured carbon material are used. For example the used fullerenes are functionalized. Functional groups are connected to the base material of the fullerenes. Moreover the use of dimers or trimers of the fullerenes is possible, too.

The particle coating comprises at least one layer with the nanostructured carbon material. In a further embodiment the layer is continuous or interrupted. E.g. an interrupted layer is achieved by isles of fullerenes which are separated from each other.

In principle the number of layers with the nanostructures carbon material is arbitrary. But especially with low numbers of these layers well thermoelectric properties result. Therefore in a preferred embodiment the particle coating comprises five layers with the nanostructured carbon material in maximum and particularly three layers with the nanostructured carbon material in maximum. In particular a monolayer with the nanostructured carbon material is suitable.

Different tellurium compounds are possible. In a particular embodiment the tellurium compound comprises at least one element selected from the group consisting of antimony (Sb) and bismuth (Bi). Further elements like lead (Pb) or selenium (Se) are possible, too. According to a preferred embodiment the tellurium compound is at least one telluride selected from the group consisting of Bi₂Te₃ and Sb₂Te₃. A Mixture of these compounds is possible as well as a solid solution of the theses compounds.

Concerning the method for making the thermoelectric nanocomposite it is preferable, that the providing of the precursor powder includes providing a powder mixture of a ceramic powder and a carbon powder, wherein the ceramic powder comprises the plurality of homogeneous ceramic nanoparticles with at least one kind of a tellurium compound having an average particle size selected from a range of about 5 nm to about 30 nm and particularly o about 10 nm, and wherein the carbon powder comprises the nanostructured, substantially intact carbon material.

According to a particular embodiment the providing the powder mixture includes milling a ceramic raw material of the ceramic powder resulting in the ceramic powder, adding the carbon powder to the ceramic powder and mixing the ceramic powder and the carbon powder such, that the powder mixture is generated. The carbon powder is added shortly before finishing the milling process or after the milling process. The milling includes ball milling or something like that.

The precursor powder can be directly subjected to the heat treatment. Better results can be achieved by compacting the precursor powder before the heat treatment. Therefore, according to a particular embodiment the providing the precursor powder includes a mechanical compacting of the precursor powder. Mechanical pressure is exerted on the precursor powder.

The resulted precursor powder is formed during the pressure process. After the pressure process heat treatment is carried out at up to 400° C. and particularly at up to 350° C.

The resulting thermoelectric nanocomposite shows excellent thermoelectric properties. The thermoelectric nanocomposite is preferably used in a component for a heat-to-power system, e.g. a Peltier element.

Beyond the advantages mentioned before following additional advantages are to be pointed out: The samples are reproducible and mechanically stable. The synthesis procedure permits optimization of the samples properties by variation of the concentration of the nanostructured carbon material. The thermoelectric nanocomposite can be synthesized in amount which is enough for devises production.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a transmission electron microscope image of nanoparticles (nano-cristallites) of Bi₂Te₃ covered by a monolayer of C₆₀ molecules.

FIG. 2 shows raman spectra of the relevant materials.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The thermoelectric nanocomposite comprises: a plurality of homogeneous ceramic nanoparticles. The tellurium compounds are in a first example a p-type of Bi₂Te₃ (Bi₂Te₃ and 26 atomic % of Sb₂Te₃) and in a second example only Bi₂Te₃. The average particle size of the nanoparticles is about 20 nm. The ceramic nanoparticles are coated with a particle coating in each case. The particle coating comprises one layer with nanostructured, substantially intact carbon material in each case. The nanostructured carbon material is unmodified fullerene C₆₀.

The method for making the thermoelectric nanocomposites comprises following steps: providing a precursor powder of a plurality of homogeneous ceramic nanoparticles, wherein the homogeneous ceramic nanoparticles comprise a precursor coating with C₆₀ molecules, and heat treatment of the precursor powder such, that the nanocomposite is generated by conversion of the precursor coating into to the particle coating.

Initial materials are following are p-type of Bi₂Te₃ (Bi₂Te₃ and 26 atomic % of Sb₂Te₃) with an impurity of less than 10⁻⁴, Bi₂Te₃ with an impurity less than 10⁻⁴ and fullerene C₆₀ with a purity of about 99.99%.

For the providing the precursor powder a milling of bulk material of the tellurium compounds into a ceramic powder and mixing with carbon powder with C₆₀ molecules is executed. For this planetary mill is rotated with acceleration of 17-19 g (acceleration of gravity). Stainless steel balls with a diameter of about 7 mm are used. A ratio of the balls to the treated material is about 8 g. Loading of the treated material was performed on glove box in argon (Ar) atmosphere. The following procedure of the treatment was selected: 1 h milling of Bi₂Te₃, adding of C₆₀ powder and 0.5 h treatment of Bi₂Te₃ with C₆₀. The compacting of the powder after the milling process was performed in a piston-cylinder cell under pressure 2 GPa. The pressurized tablets were agglomerated at 350° C. during 2 h in Ar atmosphere. Diameter of the samples is 10 mm and thickness 1 mm.

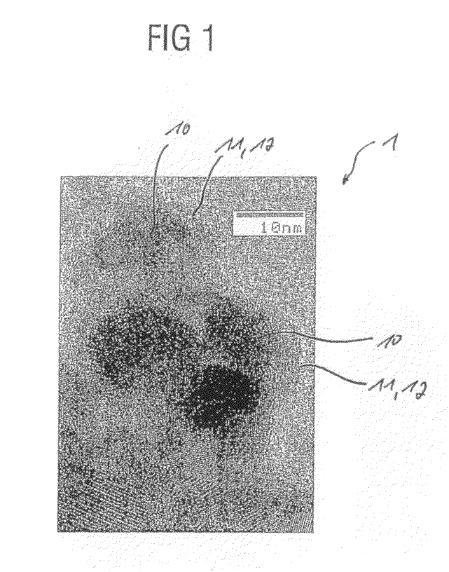

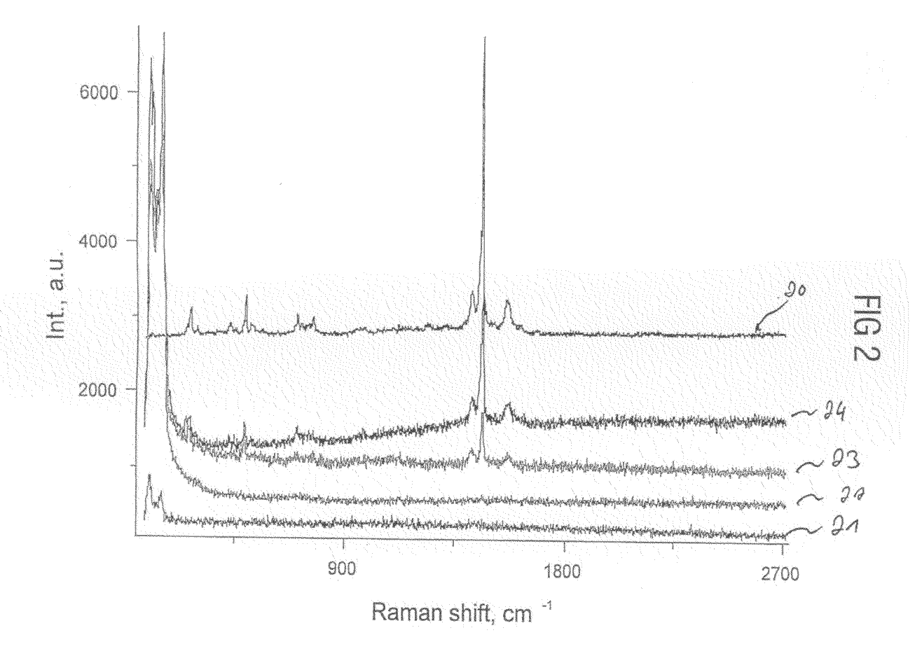

The following procedures were used for characterization of the samples: X-ray, Raman (FIG. 2), Transmission Electron Microscopy (TEM), Atomic Force Microscopy (AFM), hardness tests. FIG. 1 presents the nanocomposite 1 with the key elements: Nano-crystallites (nanoparticles) 10 of Bi₂Te₃ covered by a coating 11 with the monolayer 12 of C₆₀ molecules. The monolayer has a thickness below 1 nm. In FIG. 2 the raman spectra of the C₆₀ initial material (20), of initial p-type Bi₂Te₃ (21), milled p-type Bi₂Te₃(22), mixture of the p-type Bi₂Te₃-powder and the C60 powder (precursor powder, 23) and the heat treated precursor powder leading to the thermoelectric nanocomposite (24).

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A thermoelectric nanocomposite comprising:
a plurality of homogenous ceramic nanoparticles formed from at least one kind of tellurium compound, the ceramic nanoparticles having an average particle size of from about 5 nm to about 30 nm; and
a particle coating provided on the ceramic nanoparticles, the particle coating comprising at least one layer of nanostructured, substantially intact carbon material.

16. The thermoelectric nanocomposite according to claim 15, wherein the ceramic nanoparticles have an average particle size of from about 5 nm to about 10 nm.

17. The thermoelectric nanocomposite according to claim 15, wherein the nanostructured carbon material is selected from the group consisting of fullerenes and carbon nanotubes.

18. The thermoelectric nanocomposite according to claim 17, wherein the fullerenes are selected from the group consisting of C36, C60 and C80.

19. The thermoelectric nanocomposite according to claim 15, wherein the nanostructured carbon material is chemically modified.

20. The thermoelectric nanocomposite according to claim 15, wherein the at least one layer of the particle coating is continuous.

21. The thermoelectric nanocomposite according to claim 15, wherein the at least one layer of the particle coating is interrupted.

22. The thermoelectric nanocomposite according to claim 15, wherein the particle coating is formed from no more than five layers of nanostructured carbon material.

23. The thermoelectric nanocomposite according to claim 15, wherein the particle coating is formed from no more than three layers of nanostructured carbon material.

24. The thermoelectric nanocomposite according to claim 15, wherein the tellurium compound comprises at least one element selected from the group consisting of antimony and bismuth.

25. The thermoelectric nanocomposite according to claim 15, wherein the tellurium compound is at least one telluride selected from the group consisting of Bi₂Te₃ and Sb₂Te₃.

26. A method for making a thermoelectric nanocomposite, comprising:
providing a precursor powder of homogenous ceramic nanoparticles formed from at least one kind of a tellurium compound, the homogenous ceramic nanoparticles having an average particle size of from about 5 nm to about 30 nm, the homogenous ceramic nanoparticles of the precursor powder being coated with a precursor coating formed from at least one layer of nanostructured, substantially intact carbon material; and
performing heat treatment on the precursor powder such that the nanocomposite is generated by conversion of the precursor coating into a particle coating.

27. The method according to claim 26, wherein the ceramic nanoparticles have an average particle size of from about 5 nm to about 10 nm.

28. The method according to claim 26, wherein
providing the precursor powder comprises providing a powder mixture of a ceramic powder and a carbon powder,
the ceramic powder comprises the homogenous ceramic nanoparticles formed from at least one kind of a tellurium compound, and
the carbon powder comprises the nanostructured, substantially intact carbon material.

29. The method according to claim 28, wherein providing the powder mixture comprises:
milling a ceramic raw material of the ceramic powder to produce the ceramic powder;
adding the carbon powder to the ceramic powder; and
mixing the ceramic powder and the carbon powder such that the powder mixture is generated.

30. The method according to claim 26, wherein the precursor powder is mechanically compacted before heat treatment.

31. The method according to claim 26, wherein heat treatment is carried out at a temperature less than or equal to 400° C.

32. The method according to claim 26, wherein heat treatment is carried out at a temperature less than or equal to 350° C.

33. A heat-to-power method comprising:
providing a thermoelectric nanocomposite comprising:
a plurality of homogenous ceramic nanoparticles formed from at least one kind of tellurium compound, the ceramic nanoparticles having an average particle size of from about 5 nm to about 30 nm; and
a particle coating provided on the ceramic nanoparticles, the particle coating comprising at least one layer of nanostructured, substantially intact carbon material; and
using the thermoelectric nanocomposite as a thermoelectric component in a heat-to-power system.
